(19) United States
(12) Patent Application Publication
(10) Pub. No.: US 2001/0006184 A1
(43) Pub. Date: Jul. 5, 2001

(54) Welding wire holder

(75) Inventors: Hideaki Ohike, Hamamatsu-shi (JP); Masaru Sugimoto, Ihara-gun (JP)

Correspondence Address: MERCHANT & GOULD, P O BOX 2903, MINNEAPOLIS, MN, 55402-0903, US

(73) Assignee: Honda Giken Kogyo Kabushiki Kaisha and

(21) Appl. No.: 09/740,266

(22) Filed: Dec. 19, 2000

(30) Foreign Application Priority Data
Dec. 22, 1999 (JP) 11-365084

(51) Int. Cl. B23K 37/00; B65H 75/02; B65D 85/00

(52) U.S. Cl. 228/33; 242/590; 206/389

(57) ABSTRACT

A welding wire holder includes a container body having an annular space defined therein for receiving therein a coil of welding wire, and a coil keeper for keeping the coil of welding wire stably in position against floating when the welding wire is pulled out from the container body in an upward direction. The coil keeper is comprised of a layer of spheroidal members spread over the entire area of an upper surface of the coil of welding wire received in the annular space. The spheroidal members thus spread produce a distributed load acting on the upper surface of the coil of welding wire with uniform distribution of load.

### BACKGROUND OF THE INVENTION

1. Field of the Invention

This invention relates to a welding wire holder particularly suitable for use in an automatic welding process for holding therein a continuous welding wire in the form of a coil.

2. Description of the Related Art

FIG. 6 shows a conventional automatic welding system 100 equipped with a welding wire holder 101. The welding wire holder 101 is of the “reel” type including a wire reel 102 on which a welding wire 103 is helically would. In the operation of the automatic welding system 100, the welding wire 103 is supplied at a predetermined speed to a welding torch 106 of a welding robot 105 by means of a wire feed unit 104 while being unwound from the wire reel 102. Throughout the way from the holder 101 to the welding torch 106, the welding wire 103 is guided in and along the a hollow guide cable 107. The welding wire 103 is used as an electrode wire in the inert gas shielded arc welding process such as MIG (metal-inert gas) welding or TIG (tungsten-inert gas) welding.

Due to a limited number of turns of welding wire 103 that can be wound on a single wire reel 102, the reel type welding wire holder 101 has a limited loading capacity, such as about 20 kg for an iron-based welding wire, and about 5 kg for an aluminum-based welding wire. The reel type welding wire holder 101 therefore requires frequent replacement of the wire reel 102 which involves frequent interruption of the welding operation. Thus, the available factor or ratio of the automatic welding system 100 is relatively low.

To deal with this problem, a container type welding wire holder is used in place of the reel type welding wire holder, as shown in FIGS. 7A and 7B.

The container type welding wire holder 200 includes a bottomed outer tube 201 and an inner tube 202 disposed concentrically within the outer tube 201 so as to define therebetween an annular space in which a continuous welding wire 203 wound in the form of a cylindrical coil is received. In operation, one end of the coiled welding wire 203 is pulled out or withdrawn upwardly from an exit hole 206 formed at the top of a tapered upper part 205 of the outer tube 201 of the container type welding wire holder 200. An annular presser plate 204 is placed on the top of the coil of welding wire 203 to load the coil downward so as to prevent floating of the coil when the welding wire 203 is withdrawn from the welding wire holder 200. The presser plate 204 is a relatively lightweight member made of solid fibreboard, synthetic resin, etc.

The welding wire holder 200 of the foregoing construction has a large loading capacity increased up to about 100 kg for an iron-based welding wire, and about 70 kg for an aluminum-based welding wire. Owing to the increased loading capacity, the welding wire holder 200, when used in the automatic welding system 100 such as shown in FIG. 4, does not require frequent replacement and, hence, is able to increase the availability factor or ratio of the automatic welding system 100.

The conventional container type welding wire holder 200 has a drawback, however, that a leading end portion of the coil of welding wire 203 being unwound is likely to bounce up or get tangled, thereby thrusting the presser plate 204 upward. This tendency becomes remarkable when the welding wire 203 is made of a relatively flexible metal with low specific gravity, such as an aluminum-based welding wire.

When presser plate 204 is thrust into a floating or a tilted condition by the bouncing or entangled leading end portion of the welding wire 203, it is longer possible to exert a sufficient pressure or load on the coil of welding wire 203. Under such condition, the bounding part or the entangled part of the welding wire 203 causes jamming and cannot not be withdrawn from the container type welding wire holder 200. An attempt to increase the weight of the presser plate 204 may be made, however, use of a heavy presser plate would result in an increased resistance to the movement of the welding wire being pulled. This will hinder smooth supply of the welding wire 203 from the welding wire holder 200 to a welding torch (cf. FIG. 6), deteriorate the welding quality, and lower the productivity of the automatic welding system.

### SUMMARY OF THE INVENTION

It is accordingly an object of the present invention to provide a container type welding wire holder which is capable of holding a coil of welding wire stably in position against floating while the welding wire is pulled out or withdrawn from the container type welding wire holder in an upward direction.

To achieve the foregoing object, the present invention provides a welding wire holder comprising: a container body of double-tube structure including a bottomed vertical outer tube and an inner tube disposed concentrically within the outer tube, there being defined between the outer and inner tubes an annular wire-accommodating space for receiving therein a continuous welding wire wound around the inner tube in the form of a coil; and means for keeping the coil of welding wire stably in position against floating while the welding wire is pulled out from the container body in an upward direction. The keeping means comprises a layer of spheroidal members spread over the entire area of an upper surface of the coil of welding wire received in the wire-accommodating space.

The spheroidal members thus spread produce a distributed load acting on the upper surface of the coil of welding wire with substantially uniform distribution of load.

When the welding wire is pulled out from the welding wire holder, a leading end portion of the coil being unwound is caused to rise from the original horizontal position and thus lifts up part of the spheroidal members lying on and around the leading end portion. In this instance, however, since the reminder of the spheroidal members continues to load the coil downward, the coil as a whole is held in position against floating. In addition, since the contact area between two adjacent ones of the spheroidal members is very small and hence produces only a small resistance to the movement of the leading end portion of the coil being unwound, the welding wire can be smoothly pulled out or withdrawn at high speeds with a desired tension. This may result in improved welding qualities and high productivity of an automatic welding system in which the welding wire holder is incorporated.

The spheroidal members may be made of glass, metal or resin polymer with high specific gravity.

The layer of spheroidal members may comprise at least two sorts of spheroidal members of different shapes, such as a combination of true spherical balls and elliptical balls.

As an alternative, the layer of spheroidal members may comprise at least two shorts of spheroidal members of different sizes. The spheroidal members of different sizes may have the same shape. Preferably, the spheroidal members of different sizes comprise a combination of large-diameter true spherical balls and small-diameter true spherical balls.

In one preferred form of the present invention, the layer of spheroidal members comprises true spherical glass ball having a diameter ranging from 5 to 30 mm. The glass balls can be readily available at a relatively low cost in the market.

The above and other objects, features and advantages of the present invention will become manifest to those versed in the art upon making reference to the following description and accompanying sheets of drawings in which certain preferred structural embodiments incorporating the principle of the invention are shown by way of illustrative example.

### BRIEF DESCRIPTION OF THE DRAWINGS

FIG. 1 is a vertical cross-sectional view of a container type welding wire holder according to the present invention;

FIGS. 2A through 2D inclusive are diagrammatical views showing the manner in which the welding wire holder is assembled with a coil of welding wire held therein;

FIG. 3A is a perspective view showing a part of the welding wire holder with an upper lid removed for showing the interior of the welding wire holder;

FIGS. 3B and 3C are enlarged views of a part of FIG. 3A, illustrating the behavior of spheroidal members in conjunction with movement of a welding wire being withdrawn;

FIG. 4 is a view similar to FIG. 3A, but showing a coil keeper formed by two sorts of spheroidal members of different shapes;

FIG. 5 is a view similar to FIG. 3A, but showing a modified coil keeper formed by two sorts of spheroidal members of different sizes;

FIG. 6 is a diagrammatical view showing an automatic welding system in which a conventional reel type welding wire holder is incorporated; and

FIGS. 7A and 7B are diagrammatical views illustrative of a problem associated with a conventional container type welding wire holder.

### DETAILED DESCRIPTION OF THE PREFERRED EMBODIMENTS

The following description is merely exemplary in nature and is in no way intended to limit the invention or its application or use.

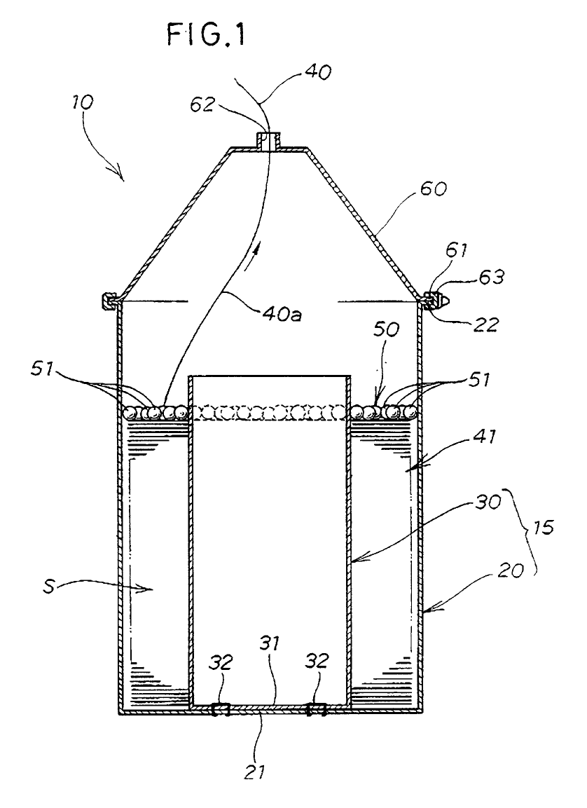

FIG. 1 shows a container type welding wire holder 10 embodying the present invention. The welding wire holder 10 includes a container body 15 having a double-tube structure including a bottomed vertical outer tube 20 and an inner tube 30 disposed concentrically within the outer tube 20.

The outer tube 20 is a bottomed cylindrical tube with an upper end open and a lower end closed by a bottom wall 21. The open upper end has an annular flange 22. The inner tube 30 is also a bottomed cylindrical tube with an upper end open and a lower end closed by a bottom wall 31. The bottom wall 31 of the inner tube 30 and the bottom wall 21 of the outer tube 20 are connected together by means of a suitable fastener such as stables 32. The outer and inner tubes 20, 30 thus assembled define therebetween an annular wire-accommodating space S for receiving therein a continuous welding wire 40 wound around the inner tube 30 in the form of a coil 41.

A conical top cover or lid 60 has an annular flange 61 formed at a lower end thereof. The lid 60 is removably attached to the flanged upper end of the outer tube 20 with the flanges 61 and 22 being connected together in superposed relation by a clamp 63. The lid 60 has an exit opening or hole 62 formed at the top thereof so that the welding wire 40 held inside the annular wire-accommodating space S in the form of the coil 41 can be pulled out or withdrawn from the exit hole 62 in an upward direction to the outside of the welding wire holder 10. The exit hole 62 is vertically aligned with the axis of the container body 15.

The container type welding wire holder 10 composed of the container body 15 and the conical lid 60 is formed from a solid fibreboard, and generally called “pail box”.

The welding wire holder 10 further includes a coil keeping means or keeper 50 for keeping the coil 41 of welding wire 40 stably in position against floating while the welding wire 40 is pulled out or withdrawn from the welding wire holder 10 via the exit hole 62. The coil keeper 50 comprises a layer of spheroidal members 51 spread over the entire area of an upper surface of the coil 41 of welding wire 40 received in the wire-accommodating space S.

The specific gravity, shape, size and material of the spheroidal members 51 are determined such that when the spheroidal members 51 are spread over the upper surface of the coil 41 of welding wire 41, a layer 50 of the spheroidal members 51 can keep the coil 41 stably in position against floating at all times when the welding wire 40 is supplied from the welding wire container 10 to a welding torch (not shown but identical to one 106 shown in FIG. 6). It is desirable that the spheroidal members 51 have good rolling capability. From this point of view, a true spherical ball and an elliptical ball are preferred examples of the shape of the spheroidal members 51. The size of the spheroidal members 51 preferably ranges from about 5 mm to 30 mm in diameter, and the materials eligible for the spheroidal members 51 include glass, metal such as iron, and resin polymer with high specific gravity.

The thickness of a layer (coil keeper) 50 of the spheroidal members 51 is determined in option. It is experimentally proved that even a single- or a double-layered spheroidal members 51 can demonstrate a sufficient suppressing effect against floating of the coil 41 of welding wire 40. Each layer of spheroidal members 51 may be composed of the same sort of spheroidal members or different sorts of spheroidal members. For instance, spherical members with the same diameter or spherical members with different diameters may be used to form a coil keeper 50 which is composed of at least one layer of spheroidal members 51 spread over the upper surface of the coil 41 of welding wire.

A most preferred form of the spheroidal member 51 is a true spherical solid glass ball with a diameter in the range of about 10 to about 30 mm. Advantageously, the glass balls have a relatively large specific gravity and are readily available at a relatively low cost in the market. The smaller the diameter of the glass balls, the greater the difficulty in spreading the glass balls neatly over the entire area of an upper surface of the coil 41 of welding wire 40. Conversely, the greater the diameter of the glass balls, the lower the suppressing effect against floating of the coil 41 of welding wire.

It is experimentally confirmed that under the test conditions specified below, glass balls can achieve substantially the same suppressing effect against floating of the coil 41 of welding wire as long as the diameter of the glass balls is in the range of 5 to 30 mm.

| Test Conditions: | | |
|---|---|---|
| Inside Diameter of Outer Tube 20: | 500 | mm |
| Height of Outer Tube 20: | 700 | mm |
| Outside Diameter of Inner Tube 30: | 300 | mm |
| Diameter of Welding Wire 40: | 1.2 | mm |
| (Aluminum-based Welding Wire) | | |

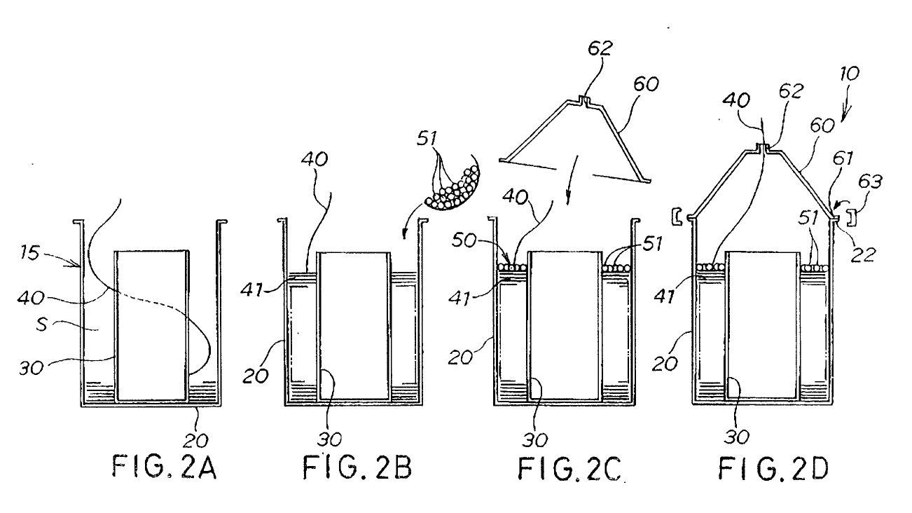

FIGS. 2A to 2D illustrate the manner in which the container type welding wire holder 10 according to the present invention is assembled with a continuous welding wire 40 held therein in the form of a coil 41.

As shown in FIG. 2A, a continuous welding wire 40 is wound around the inner tube 30 by a suitable mechanical means (not shown) until an annular wire-accommodating space S between the outer and inner tubes 20 and 30 of the container body 15 is substantially filled with a coil 41 (FIG. 2B) of welding wire.

Then, as shown in FIG. 2B, spheroidal members 51 such as glass balls are spread over an upper surface of the coil 41 of welding wire until a layer 50 of spheroidal members 51 is formed on the upper surface of the coil 41, as shown in FIG. 2C. During that time, an upper end (trailing end when viewed from the winding direction) of the welding wire 40 is kept projecting upwardly from the coil 41 so that it is not covered with the layer 50 of spherical members 51.

Thereafter, the conical lid 60 is placed on an open upper end of the outer tube 20 in such a manner that the upper end of the welding wire 40 is threaded through the exit hole 62 of the conical lid 60.

Finally, the annular flange 22 of the outer tube 20 and the annular flange 61 of the conical lid 60, which have been brought together face to face, are tightly fastened together by the clamp 63, as shown in FIG. 2D. Thus, a container type welding wire holder 10 is formed with a coil 41 of welding wire held therein.

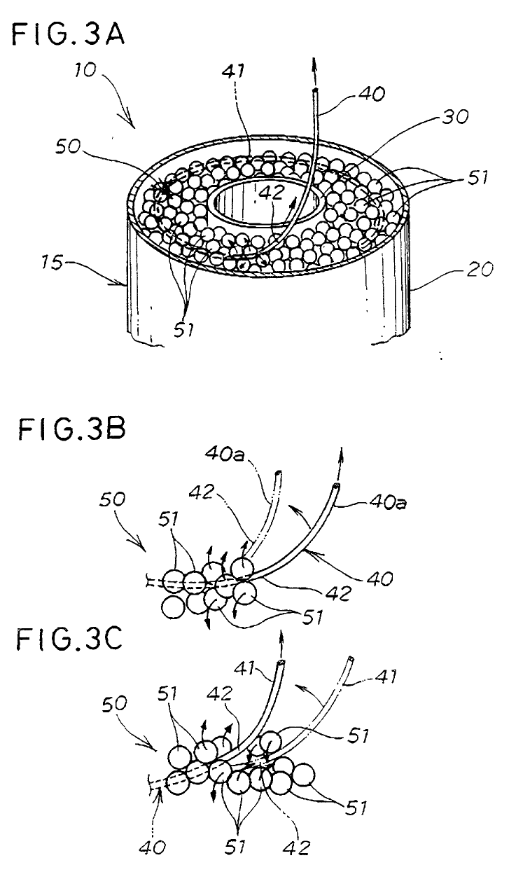

FIG. 3A shows, in perspective, an upper part of the container body 15 with the conical lid 60 (FIG. 1) removed to show the interior of the container body 15. As shown in FIG. 3A, the spheroidal members 51 are spread over the upper surface of the coil 41 of welding wire. The spheroidal members 51 thus spread forms a layer 50 and produces, by virtue of their own weight, a distributed load acting uniformly over the entire area of the upper surface of the coil 41. The layer 50 of spheroidal members 51 serves as a coil keeper to keep the coil 41 of welding wire stably in position against floating while the welding wire 40 is pulled out or withdrawn from the container type welding wire holder 10 in an upward direction, as will be understood later.

When the welding wire 40 is pulled out from the welding wire container 10 (FIG. 1) in an upward direction, a portion 40a of the welding wire extending between the exit hole 62 of the conical lid 60 and the coil 41 of welding wire moves from the position indicated by the solid line shown in FIG. 3B to the position indicated by the phantom lines shown in FIG. 3B. This movement is due to unwinding of the welding wire 40 from the coil 41. During that time, a leading end portion 42 of the coil 41 being unwound (when viewed from the direction of supply of the welding wire 40) is caused to rise from the original substantially horizontal recumbent position, whereupon those spheroidal members 51 lying on and around the leading coil end portion 42 being unwound are temporarily lifted up by the leading coil end portion 42. In this instance, however, since the spheroidal members 51 have high rolling capability peculiar to the spherical shape thereof, the temporarily lifted spheroidal members 51 soon start rolling down along the circumferential surface of the leading coil end portion 42, and upon passage of the leading coil end portion 42, they return to their original position on the upper surface of the coil 41, as indicated by the arrowheads shown in FIG. 3C.

Part of the spheroidal members 51 is lifted up by the leading coil end portion 42, but the remainder of the spherical members 51 continues to force the coil 41 of welding wire downward against floating. In addition, the lifted part of spheroidal members can immediately return to the original portion. Thus, the coil 41 of welding wire is kept stably in position against floating when the welding wire 40 is pulled out from the welding wire container 10.

In addition, since the contact area between two adjacent ones of the spheroidal members 51 is very small and hence produces only a small resistance to the movement of the welding wire 40, the leading coil end portion 42 while being unwound can smoothly slip through successive contact areas of the spheroidal members 51. With this slipping movement of the welding wire 40, it becomes possible to pull out the welding wire 40 from the welding wire holder 10 at high speeds under a desired pulling force or tension.

With the progress of the wending process, the amount of coil 41 held inside the welding wire container 10 decreases gradually. In this instance, however, since the spheroidal members 51 automatically fall or descend while keeping the layered form, the weight of spheroidal members 51 always acts on an upper surface of the coil 41 and forms a distributed load, regardless of the amount of coil 41 held inside the welding wire container 10. By thus keeping the distributed load, it is possible to preclude floating of the coil 41 of welding wire at all times when the welding wire 40 is pulled out from the welding wire holder 10 during the welding operation.

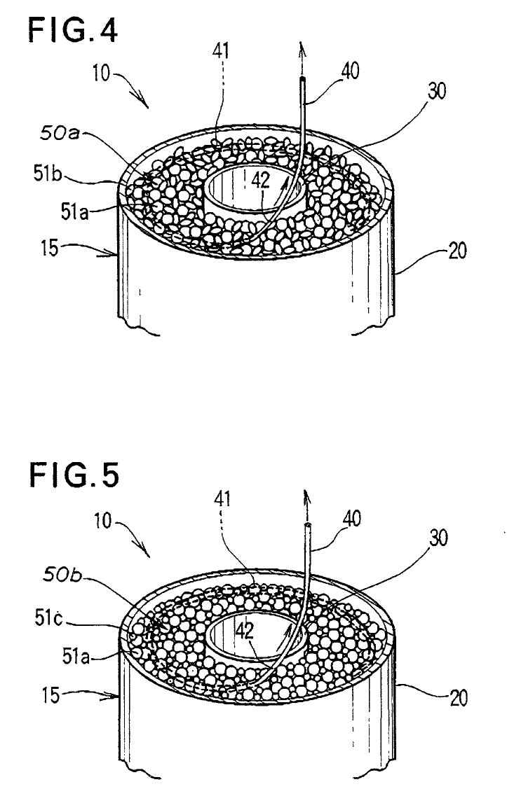

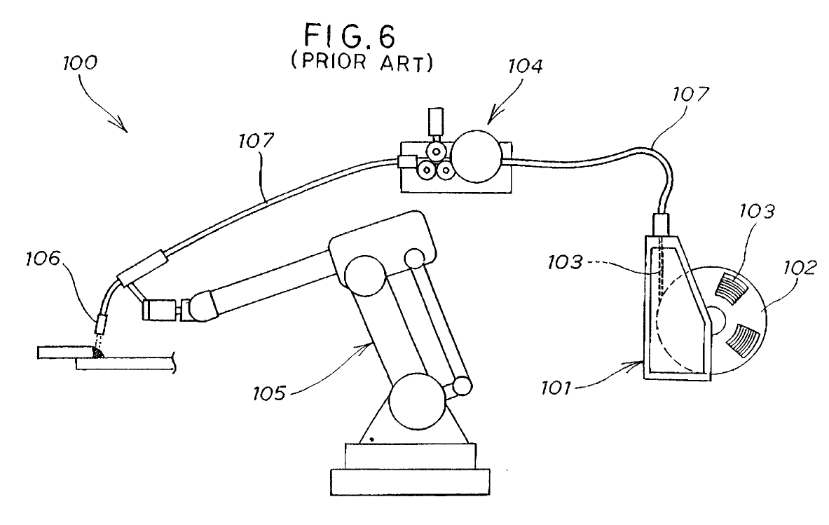

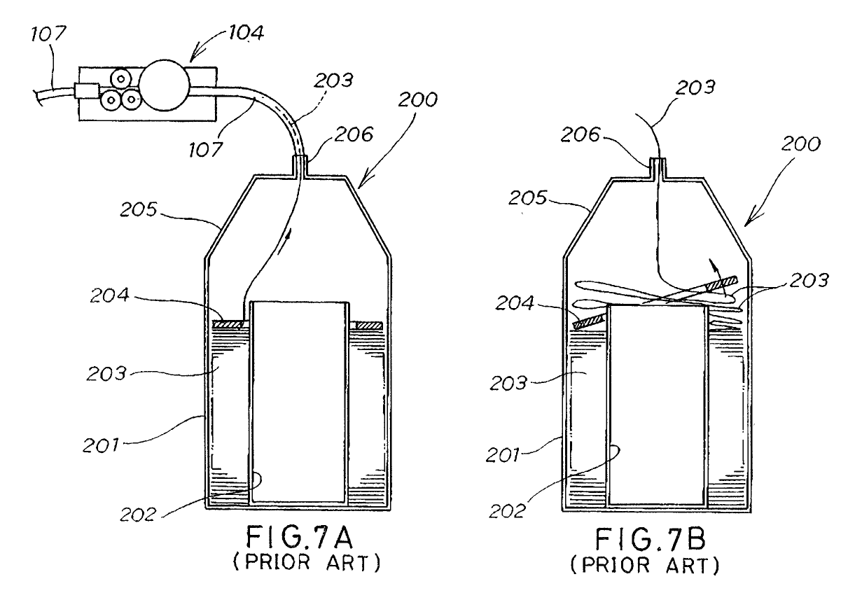

FIGS. 4 and 5 show variants of the coil keeper 50 according to the present invention. In FIG. 4, the coil keeper 50a is formed by two sorts of spherical members 51a, 51b of different shapes (that is, true spherical balls 51a and elliptical balls 51b) used in combination to form a layer spreading over the upper surface of a coil 41 of welding wire 40. In FIG. 5, the coil keeper 50b is formed by two sorts of spherical members 51a, 51c of the same shape but having different sizes (that is, large-diameter true spherical balls and small-diameter spherical balls 51c) used in combination to form a layer spreading over the upper surface of a coil 41 of welding wire 40. The coil keepers 50a, 50b can achieve the same suppressing effect against floating of the coil 41 as done by the coil keeper 50 of the embodiment shown in FIGS. 1-3.

Obviously, various minor changes and modifications of the present invention are possible in the light of the above teaching. It is therefore to be understood that within the scope of the appended claims, the present invention may be practiced otherwise than as specifically described.

What is claimed is:

1. A welding wire holder comprising:
a container body of double-tube structure including a bottomed vertical outer tube and an inner tube disposed concentrically within the outer tube, there being defined between the outer and inner tubes an annular wire-accommodating space for receiving therein a continuous welding wire wound around the inner tube in the form of a coil; and
means for keeping the coil of welding wire stably in position against floating while the welding wire is pulled out from the container body in an upward direction, the keeping means comprising a layer of spheroidal members spread over the entire area of an upper surface of the coil of welding wire received in the wire-accommodating space.

2. The welding wire holder according to claim 1, wherein the layer of spheroidal members produces a distributed load acting substantially uniformly over the entire area of the upper surface of the coil of welding wire.

3. The welding wire holder according to claim 1, wherein the spheroidal members are made of glass, metal or resin polymer with high specific gravity.

4. The welding wire holder according to claim 1, wherein the layer of spheroidal members comprises at least two sorts of spheroidal members of different shapes.

5. The welding wire holder according to claim 4, wherein the layer of spheroidal members is formed by a combination of true spherical balls and elliptical balls.

6. The welding wire holder according to claim 1, wherein the layer of spheroidal members comprises at least two shorts of spheroidal members of different sizes.

7. The welding wire holder according to claim 6, wherein the spheroidal members of different sizes have the same shape.

8. The welding wire holder according to claim 7, wherein the spheroidal members of different sizes comprise a combination of large-diameter true spherical balls and small-diameter true spherical balls.

9. The welding wire holder according to claim 1, wherein the layer of spheroidal members comprises true spherical glass ball having a diameter ranging from 5 to 30 mm.
